(19) United States
(12) Patent Application Publication
(10) Pub. No.: US 2010/0139650 A1
(43) Pub. Date: Jun. 10, 2010

(54) BURNER DEVICE

(76) Inventors: Michael Pritchard, Lancashire (GB); Robert Mitchell Rolston, Oxfordshire (GB)

Correspondence Address: STITES & HARBISON PLLC, 1199 NORTH FAIRFAX STREET, SUITE 900, ALEXANDRIA, VA, 22314, US

(21) Appl. No.: 12/595,311

(22) PCT Filed: Mar. 19, 2008
(86) PCT No.: PCT/GB2008/000965

§ 371 Date: Dec. 30, 2009

(30) Foreign Application Priority Data
Apr. 12, 2007 (GB) 0707103.8

(51) Int. Cl. F24C 3/00; F23D 14/00; B23K 26/00

(52) U.S. Cl. 126/91 A; 431/326; 219/121.72

(57) ABSTRACT

A burner tube (1) for use in an oven such as a tunnel oven. The burner tube includes a tubular body (2) having an axially extending slot (3) therein and an inlet (6) for combustible gas, the burner tube further including a metal mesh (4) which covers the slot. In use, the burner tube defines a flow path for combustible gas so that combustible gas entering the burner tube at the inlet passes through the slot and exits the burner tube through a flow area of the metal mesh. The flow area of the metal mesh is greater than the area of the slot at the outer surface of the tubular body. In use, a visible flame is anchored to the flow area of the metal mesh and the metal mesh incandesces to produce radiant heat.

The invention relates to burners and in particular to burners for ovens, especially those used in the food processing industry. The invention is particularly relevant to those burners used in direct-fired multi burner ovens.

The food processing industry is a major global consumer of energy resources, and in particular, of natural gas. It is therefore desirable to reduce the energy consumption of industrial food ovens in order to save on costs, and also, to minimise environmental impact.

The food processing industry commonly uses a type of oven known as a tunnel oven. These ovens transport a product along the length of a tunnel using a conveyor. The product is heated by a series of burners distributed at intervals along the length of the tunnel.

The burners in tunnel ovens include a burner tube. A burner tube is typically a straight cylindrical tube with an axial slot milled therein. Combustible gas (usually a mixture of fuel gas and air) is fed through the tube and exits through the slot. The combustible gas is burned as it exits the slot to produce heat for the oven. Burner tubes are mounted within the tunnel oven to be perpendicular to the direction of motion of the conveyor.

Tunnel ovens use a combination of convection and radiation to heat a product on the conveyor. A plume of hot gases produced by a burner tube rises through convection to heat the roof above the burner tube. This heat is radiated downwards by the hot roof to heat the product on the conveyor.

Burner tubes typically include a “ribbon” (a corrugated metal strip) positioned in the slot. The ribbon helps to distribute the flow of combustible gas through the slot and prevents the flame from entering the tube.

Burner tubes are mounted in tunnel ovens with their slots facing horizontally. This is primarily to ensure that the heat produced by the tubes is spread evenly across the roof for top burner tubes (i.e. burner tubes mounted above the conveyor) and to project heat forwards of the burners so that “back radiation” of heat from the roof onto the burner tubes is minimised. This means that the radiant heat provided by the oven roof is produced more evenly and safely than if the slots faced vertically.

Burner tubes are traditionally manufactured by drilling a series of holes across the bore of a tube at regular intervals along its length. Cross-pins are subsequently inserted and into the holes and welded in place. The slot is then milled in the tube. The cross-pins are present to prevent the slot from opening out during machining of the tube. The ribbon is then assembled and inserted into the slot where it rests on the cross-pins. The ribbon is secured in place by deforming the edges of the slot to press against the ribbon at regular intervals along the tube using a centre punch.

A problem sometimes associated with tunnel ovens is that more heat is supplied to products which are nearer the centre of a burner tube (i.e. in the centre of the conveyor) than those which are nearer the edges of a burner tube (i.e. on the sides of the conveyor). This may be referred to as the “edge heating problem”.

At its most general, this invention provides a burner tube which is adapted to, in use, produce a visible flame area which is greater than the area of a slot therein and/or have a mesh with an incandescing area which is greater than the area of said slot. Burner tubes in accordance with this invention have been found to be more efficient than previous burner tubes. Therefore, this invention contributes towards reducing the operating costs, and the environmental impact, of industrial ovens.

According to one aspect of the present invention there is provided a burner tube for use in an oven, the burner tube including: a tubular body having an axially extending slot therein and an inlet for combustible gas; and a metal mesh which covers the slot; in use, the burner tube defining a flow path for combustible gas so that combustible gas entering the burner tube at the inlet passes through the slot and exits the burner tube through a flow area of the metal mesh; wherein, the flow area of the metal mesh is greater than the area of the slot at the outer surface of the tubular body.

Thus, the flow area of the mesh refers to the area of the mesh through which combustible gas exiting the burner tube through the slot is able to flow when combustible gas is fed into the tube. When the burner tube is in use, combustible gas is burned as it exits through the mesh so that a visible flame is produced across the flow area of the mesh. Therefore, the area of visible flame is larger for a tube according to this aspect of the invention than for an equivalent tube in which the flow area is less than or equal to the area of the slot at the outer surface of the tubular body.

For the avoidance of doubt, the area of the slot in the outer surface of the tubular body refers to the area defined by the perimeter edge of the slot at the outer surface of the tubular body.

The inventors have found that a burner tube according to this aspect of the invention is more efficient at heating a product than an equivalent burner tube having a flow area that is less than or equal to the area of the slot. The “efficiency” of a burner tube refers to the ratio of heat delivered to a product by the burner tube over the input energy (i.e. the volume of combustible gas supplied to the burner tube). It is thought that the improved efficiency of a tube according to this aspect of the invention may be due to additional radiant heat being produced by the larger visible flame when the burner tube is in use.

Preferably the flow area of the mesh is at least 1.5 times, more preferably at least 2 times, even more preferably at least 3 times, 4 times, 5 times or more times the area of the slot at the outer surface of the tubular body. An increased flow area of the mesh relative to the area of the slot at the outer surface of the tubular body has been found to provide a further improvement in the efficiency of the burner tube. Optimal efficiency improvement has been found with a flow area which is at least 4 times the area of the slot. In practice, the flow areas of burner tubes may conveniently be in the range 3 to 5 times the area of the slot at the outer surface of the tubular body.

Having a mesh which covers the slot has been found to be more effective for the reduction of “flashback” than the ribbon used in the prior art. “Flashback” is a term used to describe a situation where combustible gas ignites inside a burner tube. If “flashback” goes undetected, it can cause very rapid deterioration of the burner tube with potentially dangerous consequences. “Flashback” is particularly reduced if the structure of the metal mesh is such that there is a high insulating factor between the inner and outer surfaces of the mesh which ensures that the flame is retained on the outer surface of the mesh. Thus, the mesh may be a structured metal fibre which may suitably be a knitted metal fibre.

The metal mesh is preferably a good electrical conductor for ignition and flame sensing purposes. In addition, the metal is preferably one which is detectable using industrial detection equipment so that any contamination of a product by the mesh can be detected by industry standard metal detection equipment which can identify ferrous and non-ferrous metals.

Preferably, the mesh is of a metal which incandesces at combustion temperatures, particularly a material that incandesces at temperatures in the range 600° C. to 1200° C., more preferably in the range 750° C. to 1200° C. This means that in use, when combustible gas is burned as it exits the flow area of the mesh, the heat produced by the combusting gas will cause the flow area of the mesh to incandesce. The inventors have found that this results in a particularly efficient burner tube. It is thought that the further improvement in efficiency is due to additional radiant heat being produced by the incandescent area of the mesh which heats the product directly. Because having an incandescent mesh is thought to be responsible for an improvement in efficiency which increases with the size of the area of incandescent mesh, the term “incandescent area” may be used in place of “flow area” in this aspect of the invention.

Having a mesh which is capable of incandescence is also advantageous as it acts as an indicator of whether the flame is anchored to the mesh surface. When using high combustible flow gas rates through the burner tube, the visible flame may lift off the surface of the mesh so that the temperature of the mesh surface falls and the mesh stops incandescing. If this happens, an operator who observes that the mesh is no longer incandescing can adjust the flow rate of combustible gas so that the flame becomes re-anchored to the mesh.

Any metal or alloy with suitable temperature characteristics may be used as the material for the mesh. One suitable material for the mesh is Fecralloy™ as it incandesces at high temperature and is a good conductor of electricity. Fecralloy™ is an Fe—Cr—Al steel containing Iron, Chromium and Aluminium in the proportions 73%, 22% and 4.8% respectively. Fecralloy™ also contains Yttrium which contributes to improved oxidation resistance and a high temperature lifetime. A suitable Fecralloy™ mesh is currently sold by the trade name “Nitmesh” which is a knitted Fecralloy™ mesh with a high insulating factor between its inner and outer surfaces so is particularly good at preventing “flashback”.

The metal mesh is preferably attached directly to the outer surface of the tubular body, i.e. contacting each other without intermediary. In other words, the metal mesh is preferably contiguous with (i.e. touches) the outer surface of the tubular body. Attaching the mesh directly to the exterior saves on cost compared with previous methods. This direct attachment may be achieved by welding the mesh to the outer surface of the tubular body.

Preferably, the mesh is spaced apart from the area of the slot at the outer surface of the tubular body, i.e. so there is a space located between the mesh and the slot. In use, combustible gas exiting the slot fills the space and is able to exit through all parts of the mesh which are adjacent to the space. Therefore, this arrangement achieves a flow area which is greater than the area of the slot at the outer surface of the tubular body.

The mesh is preferably mounted on a porous layer positioned between the mesh and the slot. The mesh may be mounted to the porous layer by welding. The porous layer may be attached to the tubular body directly, e.g. by welding.

The porous layer is preferably configured so that, in use, it distributes combustible gas in a direction substantially perpendicular to the direction of combustible gas flow through the mesh. This may increase the flow area of the mesh relative to the area of the slot at the outer surface of the tubular body and/or help to distribute the flow of gas through the mesh more evenly. The porous layer may be a perforated metal plate or a wire frame structure.

The porous layer is preferably rigid. This enables the porous layer to support the mesh. This support is especially useful if the mesh is non-rigid. For example, the material sold by the trade name of “Nitmesh” (discussed above) is non-rigid.

The inventors have found that a perforated metal plate is a particularly suitable porous layer. Each perforation in the metal plate preferably includes a bridge extending across an opening so that, in use, the bridge acts as a baffle in order to distribute combustible gas in a direction substantially perpendicular to the direction of flow of combustible gas. Preferably, the bridges distribute combustible gas in an axially extending direction, i.e. so the opening under the bridge extends in a direction parallel to the axis of the tubular body. A particularly suitable material for the perforated metal plate is stainless steel. Mild steel may be used as a material for the perforated metal plate, but stainless steel is preferred.

The burner tube preferably has only one mesh structure which covers the slot. In other words, the burner tube preferably has only one mesh structure which, when the burner tube is in use, lies in the flow path of combustible gas exiting the burner tube. The only one mesh structure may be a layered structure, i.e. it may include more than one layer. For example, the single mesh structure may be a layered structure including the metal mesh and the porous layer. Having only one mesh structure provides a simple arrangement which is easy to manufacture. Additionally, having a single mesh structure is advantageous over having multiple mesh structures because having multiple mesh structures covering the slot could result in greater pressure loss of combustible gas exiting the burner tube when the burner tube is in use.

The metal mesh is preferably at the outermost surface of the burner tube. In other words, the burner tube preferably does not include parts which cover (partially or wholly) the metal mesh. By this arrangement, when the burner tube is in use such that there is a flame anchored to the metal mesh and/or the metal mesh is incandescing, the efficiency of the burner tube is maximised. This is because if the metal mesh was partially or wholly covered, then the part of the burner tube which covered the metal mesh is likely to absorb some of the radiant heat, thus reducing the efficiency of the burner tube.

The tubular body is preferably straight. It is also preferably cylindrical. Straight, cylindrical tubular bodies are available cheaply thus saving on the cost of the burner tube. The tubular body is preferably of mild steel, stainless steel, Inconel™, Monel™ or any other material suitable for laser cutting and welding.

The dimensions of the tubular body should be selected according to the desired properties of the burner tube. The tubular body may have an internal diameter in the range 20 mm to 100 mm. The tubular body may have a thickness in the range 2 mm to 20 mm or 5 mm to 20 mm. For example, the tubular body may have a British Standard heavy gauge internal diameter of 38.1 mm (1.5 inches), which may have an outer diameter of 49 mm. As another example, the tubular body may have the British Standard heavy gauge internal diameter of 50.8 mm (2 inches), which may have an outer diameter of 61 mm. The length of the tube may be less than 3 metres.

The burner tube is preferably sized so as to fit through the access aperture of a tunnel oven. This allows the burner tube to be fitted into an existing tunnel oven without requiring the tunnel oven to be dismantled. Examples of typical access apertures of tunnel ovens include a circular aperture having a diameter of 70 mm for a burner tube having an inner diameter of 32 mm (1.25 inches) and a rectangular aperture having dimensions 70 mm by 110 mm for a burner tube having an inner diameter of 38 mm (1.5 inches). However, tunnel ovens may have an access aperture as large as 170 mm or even 200 mm. Therefore, the outer diameter of the burner tube (i.e. the diameter of the tubular body and any parts projecting outwardly therefrom) is preferably less than 200 mm, more preferably less than 150 mm, more preferably less than 100 mm, more preferably less than 70 mm, 60 mm or 50 mm.

The width of the slot depends on the thermal requirements of the burner tube. The slot width may be in the range 4 mm to 12 mm. For example, the slot width may be in the range 4 mm to 8 mm for a burner tube with an internal diameter of 38.1 mm (1.5 inches) and may be in the range 8 to 12 mm for a burner tube with an internal diameter of 50.8 mm (2 inches).

Preferably, the burner tube does not include moving parts. This makes the burner tube easier to manufacture and more reliable in use, since moving parts are particularly susceptible to breaking.

This aspect of the present invention also provides a number of proposals for correcting the “edge heating problem” (previously described) sometimes associated with tunnel ovens. These proposals are particularly relevant to burner tubes according to this aspect of the invention, as it is thought that the additional radiant heat produced by these burners may intensify the “edge heating problem”. These proposals each provide a tube burner which is capable of producing more heat at an end of the axially extending slot than in the centre of the slot (and/or the centre of the burner tube). Although the proposals are outlined in respect of one end of the slot, it is preferable for the proposals to be used in respect of both ends of the slot (in a burner tube having a single slot) or for the proposals to be used in respect of the slots at either end of the burner tube (in a burner tube having a plurality of slots). The proposals outlined below can be used on their own or in any combination.

One proposal for correcting the “edge heating problem” is for the axially extending slot to widen towards an end of the slot. Preferably, the widening is gradual, i.e. so the slot is flared at its end. Because the slot is wider at the end, in use, more combustible gas will flow through the mesh at the end of the slot relative to the centre of the slot. Thus, more heat will be produced at the end of the slot.

Another proposal for correcting the “edge heating problem” is for the tubular body to include one or more additional openings at an end of the slot. The additional openings are preferably covered by the mesh so that, in use, combustible gas passing through the additional openings will exit the burner tube through the mesh. Alternatively, the additional openings may be covered by one or more additional meshes. The one or more additional openings may include a transverse slot, i.e. a slot extending in a direction transverse to the axially extending slot. The transverse slot may be perpendicular to the axially extending slot. Alternatively, the one or more additional openings may include one or more holes which may be arranged beyond the end of the slot, or alternatively, alongside the slot. In use, the additional openings serve to increase the flow of gas through the mesh at the end of the slot and therefore increase the amount of heat produced at that end.

A further proposal is for the flow area of the mesh to widen towards an end of the slot. In this arrangement, when the burner tube is in use, more radiant heat is produced by the visible flame and/or the incandescing mesh at the end of the slot. The flow area may widen gradually at an end of the slot, so that it is flared at the end. Alternatively, the widening may be non-gradual (i.e. so that the mesh widens in one or more discrete steps).

Another proposal is for each burner tube to be provided with a distributor having at least two distribution pipes for supplying different flow rates of combustible gas to at least two zones which are axially distributed within the tubular body (this may be referred to as a “multizone” burner tube arrangement). The zones may be separated by internal baffles within the tubular body. The zones are preferably arranged so that the distributor is able to supply increased combustible gas flow rates to the zones at the ends of the tubular body relative to the combustible gas flow rates to the zone(s) in the centre of the tubular body so that, in use, the heat produced by the burner tube is increased at its ends. A preferable number of zones is three (a “trizone” burner tube arrangement).

The tubular body may include a plurality of axially extending slots therein, rather than a single slot. The plurality of slots may be linearly arranged end on end with bridges in the tubular body therebetween. In this arrangement, the bridges prevent the slots from opening up during machining of the tubular body, thus eliminating the need for cross-pins. Preferably, the plurality of slots are covered by a single mesh to save on cost. The slots may be less than 200 mm in length (e.g. 150 mm). The bridges in the tubular body may be less than 10 mm in length, more preferably less than 5 mm in length (e.g. 4 mm). The bridges may have a width which is substantially equal to the thickness of the tubular body.

In another aspect of the present invention there is provided an oven including one or more burner tubes as defined above. The oven may include any suitable ignition means for igniting combustible gas exiting through the burner tubes in use. For example, the ignition means may be a high tension spark electrode which may be adapted to spark directly onto the mesh. The oven may be a tunnel oven (i.e. it may include a tunnel).

The oven preferably includes a conveyor having a surface for transporting a product (e.g. biscuits) through the tunnel thereon. The direction of motion of the conveyor is preferably horizontal. The conveyor surface may be any suitable surface for carrying a product thereon, such a belt or an open mesh surface. An open mesh surface may be advantageous as it allows radiant and convective heat to be transmitted therethrough. Suitable materials for the conveyor surface may include mild steel or stainless steel.

The burner tubes may be mounted in any configuration within the oven. In particular, the burner tubes may be mounted above and/or below the conveyor surface. A preferred arrangement is where each burner tube is mounted with its axis (i.e. the axis of the tubular body) transverse to the direction of motion of the conveyor. “Transverse” is intended to mean not parallel, i.e. crossing the conveyor at any desired angle. More preferably, each burner tube is mounted with its axis substantially perpendicular to the direction of motion of the conveyor. The axis of the tubular body is preferably substantially parallel to the conveyor surface.

By “axis” of the tubular body, it is meant the axis of symmetry of the tubular body. However, the invention is not limited to tubular bodies having an axis of symmetry.

A line may be defined which extends perpendicularly from the axis of the tubular body and passes through the centre of the slot. Preferably, the burner tubes are mounted such that this line is inclined towards the conveyor, in other words, inclined towards the conveyor with respect to the direction of motion of the conveyor (which may be horizontal). It has been found that by mounting the burner tubes in this way, further efficiency gains can be obtained. It is thought that the line defined above is the direction in which a large proportion of the radiant heat from the visible flame and/or the incandescing mesh is produced. Therefore, it is thought that the further efficiency gains are due to more of the radiant heat produced by the visible flame and/or incandescing mesh of the burner tube being directed towards the conveyor (and therefore towards a product on the conveyor).

Preferably, each burner tube is mounted so that the line also passes through the conveyor surface, so that more of the radiant heat produced by the burner tube is directed towards the conveyor surface.

Preferably, the angle between the line and the direction of motion of the conveyor is in the range 0° to 50°, more preferably in the range 20° to 40°.

In another aspect of the invention, there is provided a method of producing a burner tube including a step of forming an axially extending slot in a tubular body by laser cutting. Alternatively, a plurality of axially extending slots (e.g. as described previously) may be formed by laser cutting. Laser cutting greatly reduces the time and effort required to make a burner tube compared with previous processes. In addition, as the drilling and welding of the cross pins in the tube is omitted, the tubular body is subject to a reduced amount of heat stress.

Embodiments of our proposals are discussed below, with reference to the accompanying drawings in which:

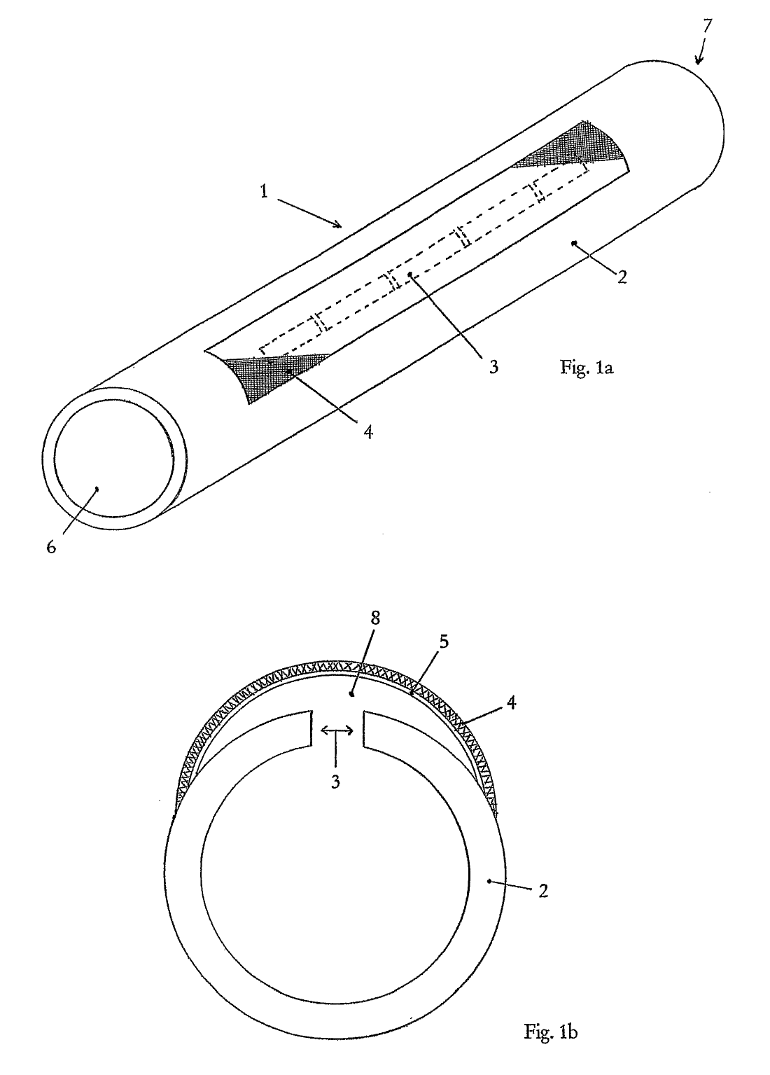

FIG. 1a is a perspective view of a burner tube.

FIG. 1b is a cross-sectional view of the burner tube of FIG. 1a.

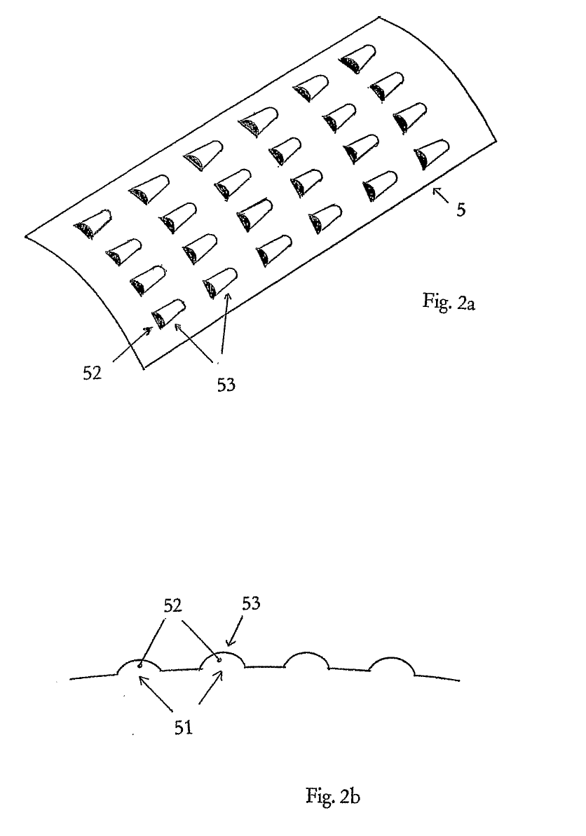

FIG. 2a is a perspective view of the perforated metal plate of the burner tube shown in FIG. 1a.

FIG. 2b is a cross-sectional view of the perforated metal plate of the burner tube shown in FIG. 1a.

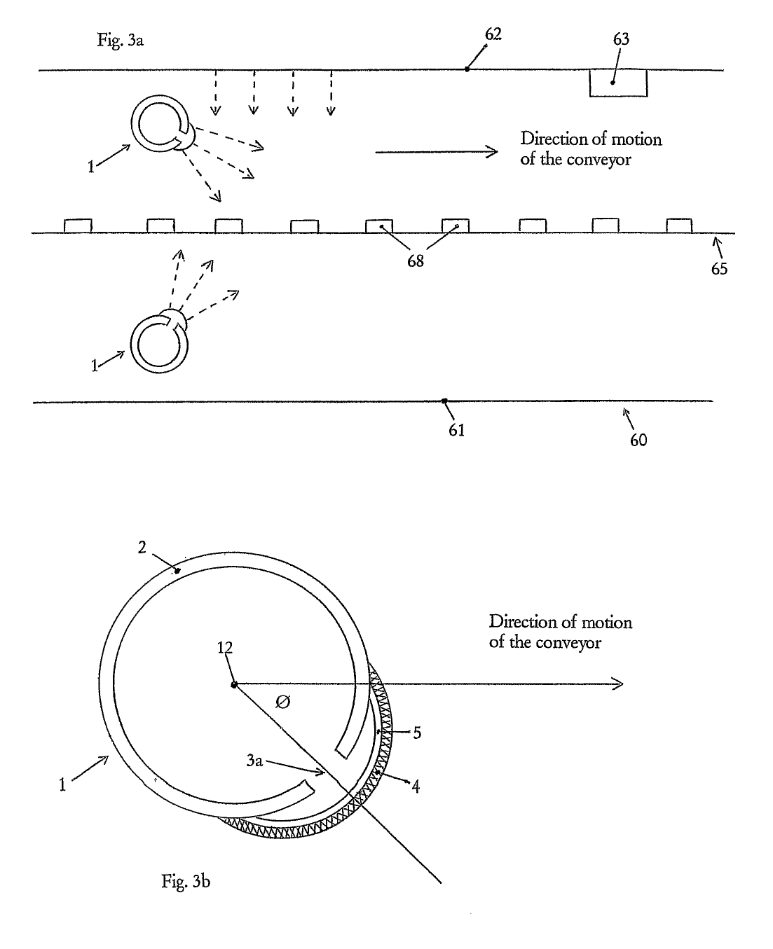

FIG. 3a is a side cross-sectional view of a tunnel oven which includes two of the burner tubes shown in FIG. 1a.

FIG. 3b is an enlarged view of the burner tube mounted above the conveyor shown in FIG. 3a.

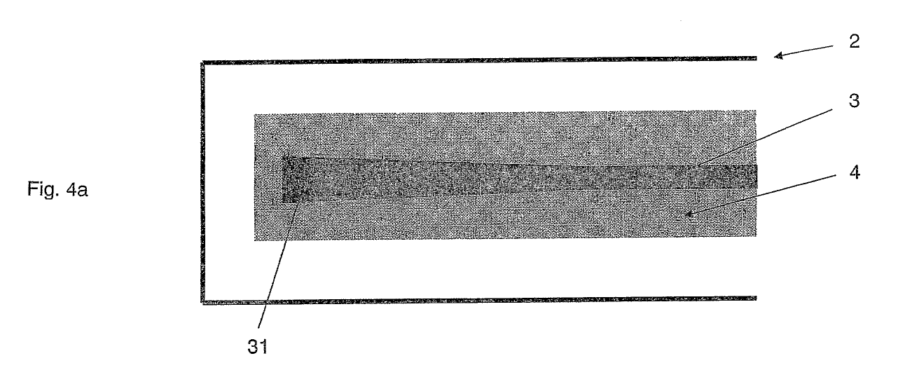

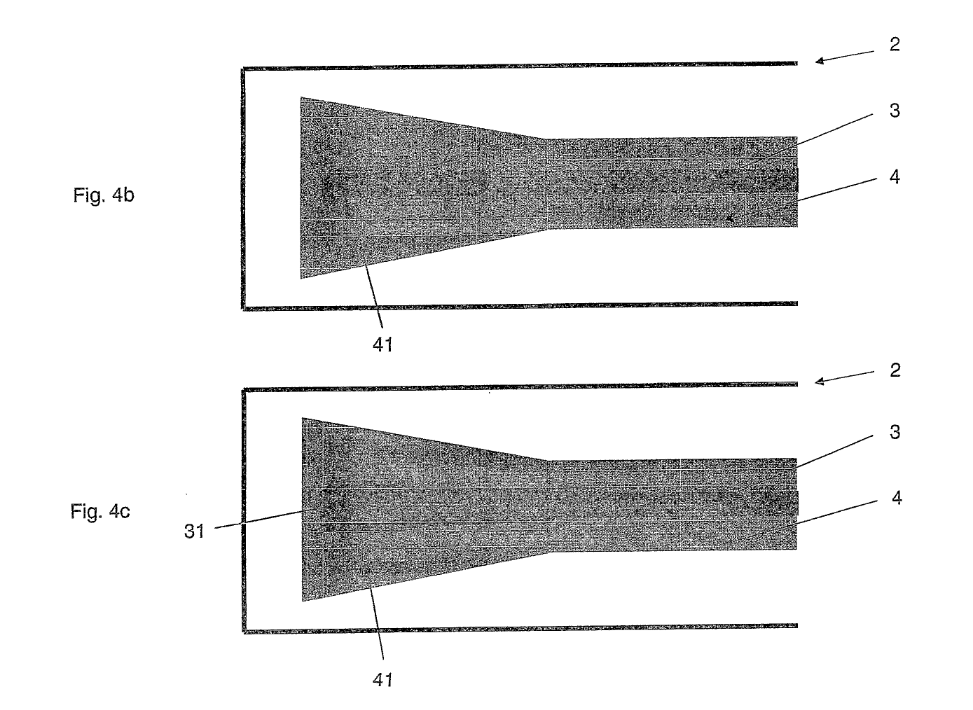

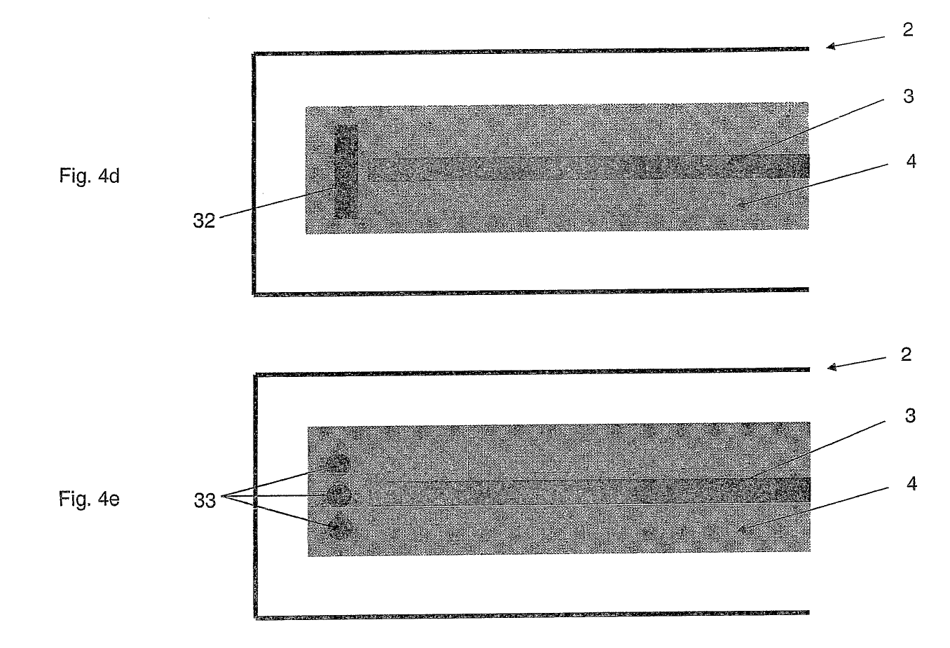

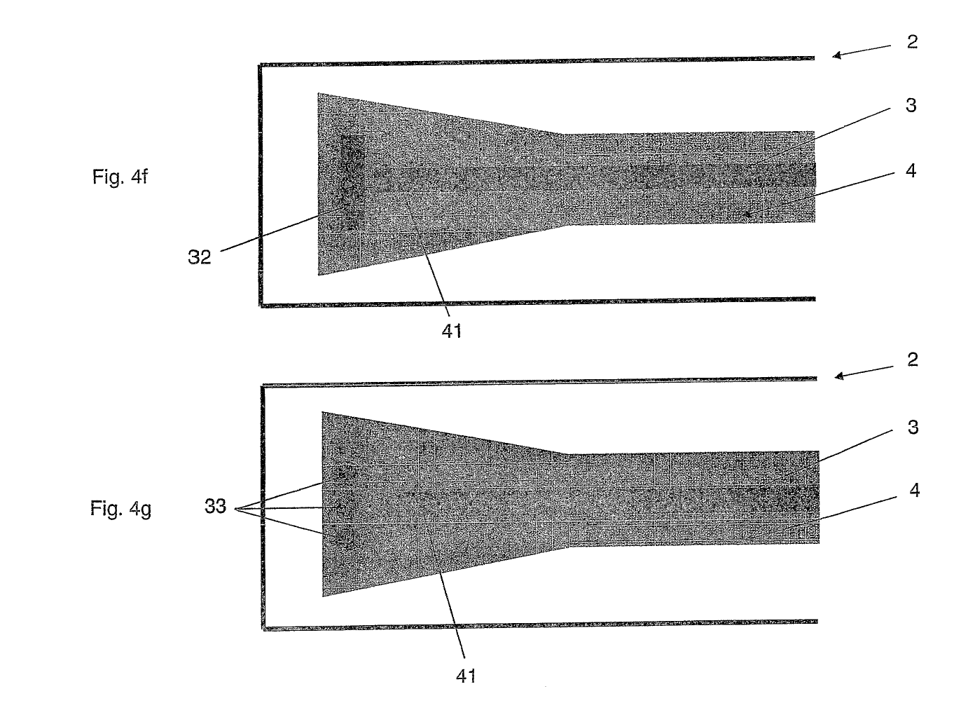

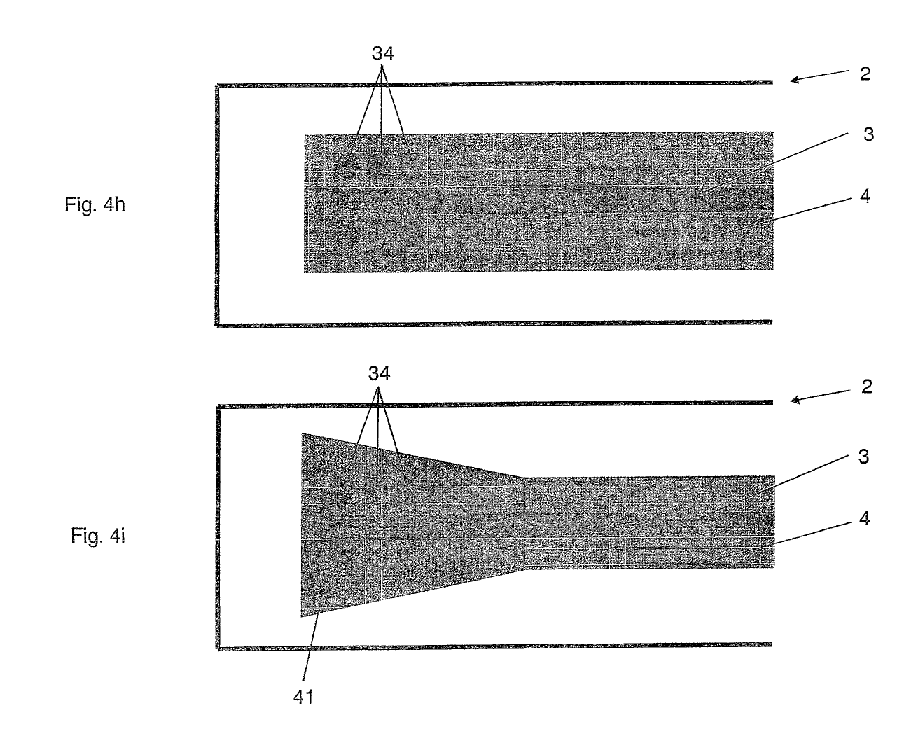

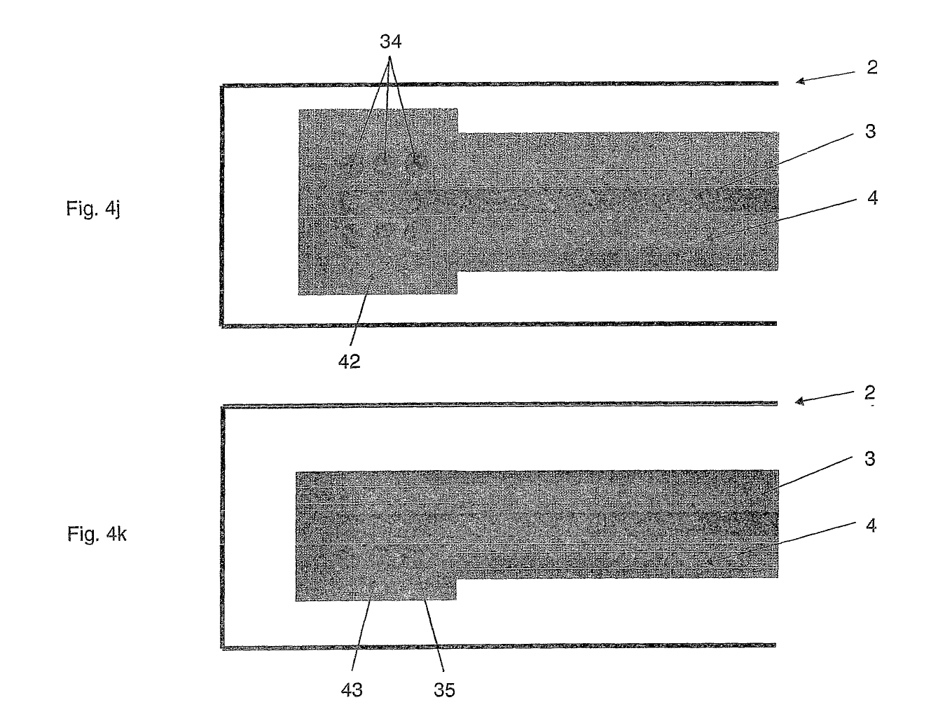

FIGS. 4a to 4l show various configurations of the burner shown in FIG. 1a, for correcting the “edge heating problem”.

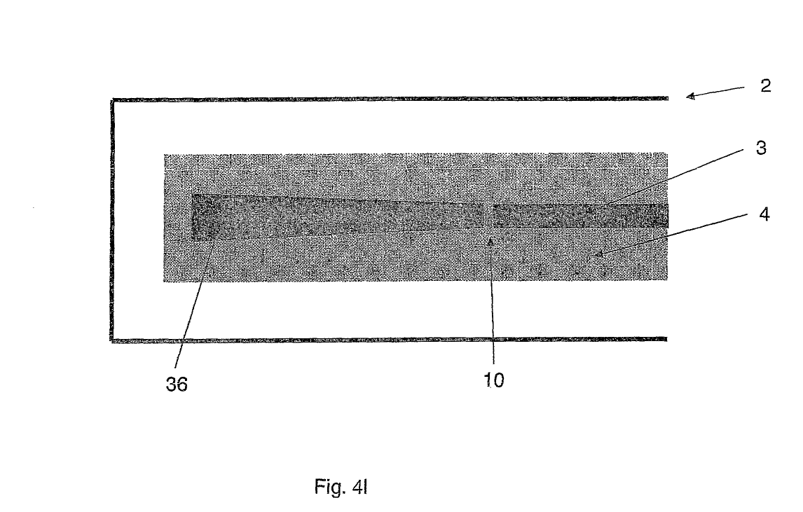

FIG. 5 shows a “multizone” burner tube arrangement of the burner tube shown in FIG. 1a.

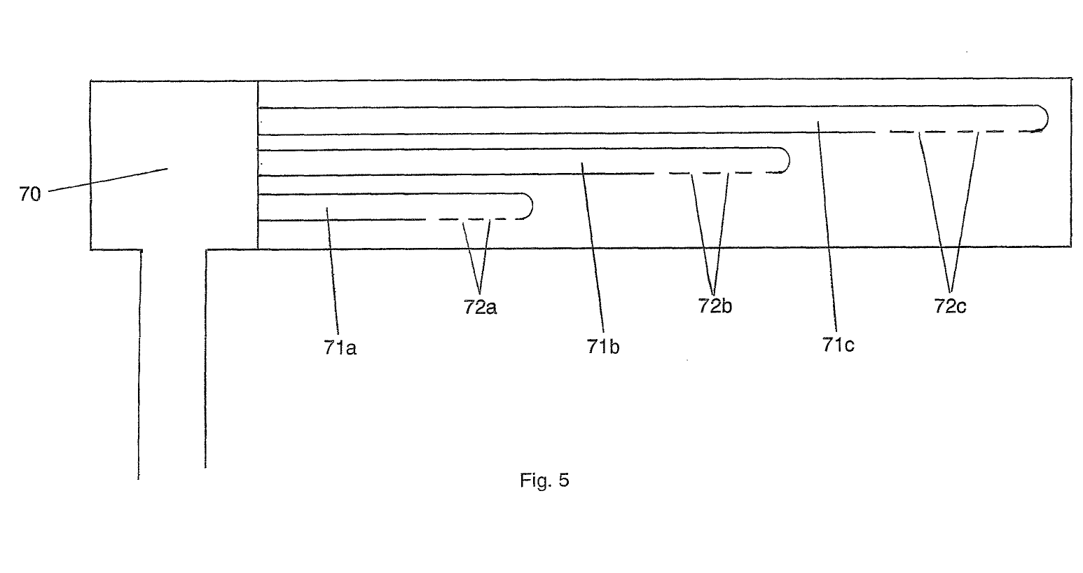

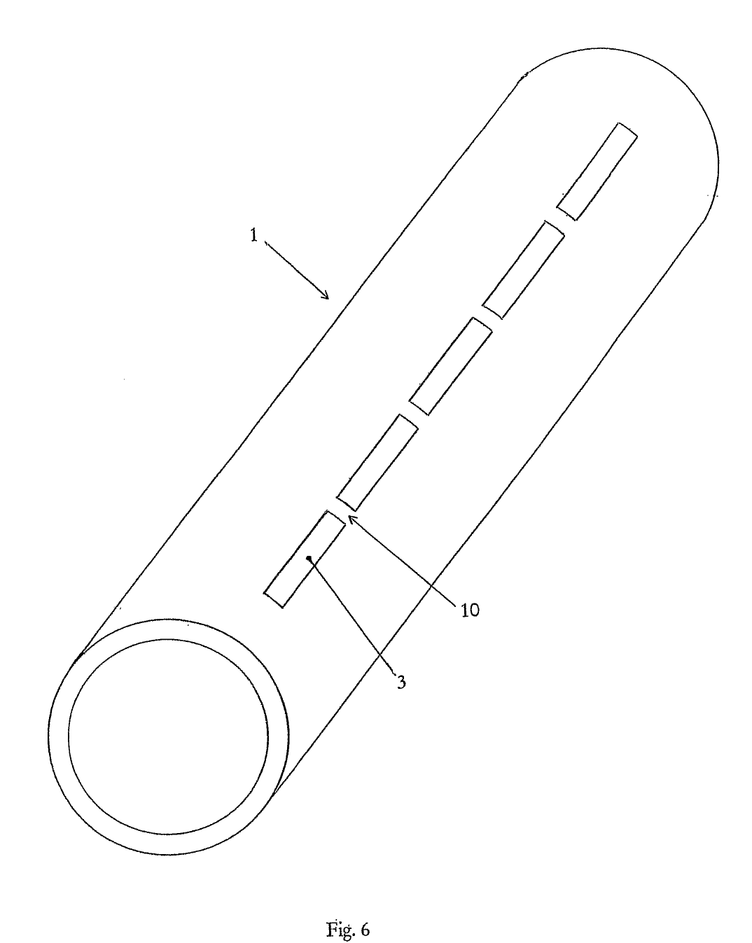

FIG. 6 shows an alternative form of the tubular body of the burner tube of FIG. 1a.

FIGS. 1a and 1b show a burner tube 1 for use in a tunnel oven. The burner tube 1 includes a tubular body 2 made from British Standard 1387 heavy gauge mild steel having a plurality of axially extending slots 3 therein. The slots 3 are indicated in FIG. 1a by dashed lines. The slots 3 are covered by a mesh 4 (shown by cross-hatching in FIG. 1a). The mesh 4 is mounted on a plate 5 and is welded onto the outer surface of the tubular body 2. The opening 6 at one end of the tubular body 2 provides an inlet for combustible gas to be fed into the tubular body 2. The opposite end 7 of the tubular body 2 is sealed. The slots 3 in tubular body 2 have been formed by laser cutting.

The mesh 4 is a knitted metal fibre made from Fecralloy™. Fecralloy™ is an Fe—Cr—Al steel with high resistance to oxidation at high temperatures. The Fecralloy™ knitted metal fibre used in this embodiment is sold by the trade name of “Nitmesh”. “Nitmesh” is effective for reducing the risk of “flashback” in the burner tube 1. In addition, at temperatures in the range 600° C. to 1200° C. “Nitmesh” becomes incandescent.

In use, combustible gas (in this case pre-mixed fuel gas and air) is fed into the burner tube 1 via opening 6. The gas then exits tubular body 2 through slot 3, then through the plate 5, and then through the mesh 4.

As shown in FIG. 1b, the mesh 4 is spaced apart from the slots 3 by an axially extending space 8. If the mesh 4 were not spaced apart from the slots 3 (i.e. if the mesh 4 were flush with the slot 3), combustible gas exiting the slots 3 would only be able to flow through the part of the mesh 4 directly adjacent the slots 3. However, in the arrangement shown in FIG. 1b, gas exiting the slots 3 fills the space 8 and exits through all parts of the mesh 4 adjacent the space 8. This means that the surface area of mesh 4 through which combustible gas exiting the slots 3 can flow (i.e. the flow area of the mesh 4) is greater than the area of the slot 3 at the outer surface of the tubular body 2.

In use, combustible gas exiting through the flow area of the mesh 4 is ignited by a high tension spark electrode or any other suitable ignition means. The combusting gas produces a visible flame which is anchored to the flow area of the mesh 4 so that the flow area of the mesh 4 heats up. As the flow area of the mesh 4 heats up to temperatures over 600° C., the flow area of the mesh 4 becomes incandescent.

FIGS. 2a and 2b show the plate 5 of FIG. 1a in more detail. The plate 5 is of stainless steel and includes a plurality of perforations 51 therein. As can be seen from FIG. 2b, each perforation consists of a raised bridge 53 with an axially extending opening 52 beneath. The bridges 53 act as baffles for combustible gas passing through the perforations 51 so that combustible gas is distributed along the axis of the tubular body 2. The inventors have found that this configuration for the plate 5 helps improves the distribution of combustible gas flow through the mesh 4. Because the plate 5 is rigid, it helps to maintain the space 8 between the mesh 4 and the slots 3.

FIG. 3 shows how the burner tube 1 might be used in a tunnel oven 60. The part of the oven 60 shown in the drawing includes a base 61, a roof 62, a conveyor 65, an extraction duct 63 and two of the burner tubes 1 shown in FIG. 1a. A plurality of products 68 (e.g. biscuits) for heating are placed on the carrying surface of the conveyor 65. The burner tubes 1 are mounted perpendicularly across the direction of motion of the conveyor 65 and parallel to the carrying surface of the conveyor 65. The burner tubes 1 are arranged to receive combustible gas from a gas supply (not shown) through the openings 6. A high tension spark electrode (not shown) is used to ignite the gas exiting through the mesh 4 of each of the burner tubes 1. When the oven is in use, the flow areas of the mesh 4 of each burner tubes 1 become incandescent as previously described.

The products 68 are heated up by two different mechanisms. Firstly, the burner tubes 1 produce a plume of hot gas which rises (by convection) to heat the roof of the oven 60. The hot roof 62 of the oven 60 radiates this heat downwards to heat the products 68 on the conveyor 65 (radiant heat is shown by dashed lines in FIG. 3). In addition, the plume of hot gas produced by the burner tube 1 located below the conveyor 65 rises to heat the conveyor 65 directly by convection (and also the products 68 directly when the conveyor 65 is an open mesh conveyor). Secondly, the visible flames and the incandescing meshes 4 on the burner tubes 1 produce radiant heat (shown by dashed lines in FIG. 3) which heats the products 68 directly.

It has been found that the burner tubes 1 are more efficient at supplying heat to a product than previous burner tubes. In other words, burner tubes 1 supply more heat to the products 68 for a given volume of input combustible gas. It is thought the improvement in efficiency may be caused by additional radiant heat being produced by the visible flame and the incandescing mesh 4 which heat the products 68 directly.

Usually, tunnel ovens orient their burner tubes so that a line extending perpendicularly from the axis of each burner tube and passing through the centre of the slot (or slots) is parallel to the direction of motion of the conveyor, so that the burner tubes fire horizontally. However, in the arrangement shown in FIG. 3a, each burner tube 1 is mounted so that there is an acute angle θ between the direction of motion of the conveyor and the line which extends perpendicularly from the axis 12 of the tubular body 2 and passes through the centre 3a of one of the slots 3. FIG. 3b shows the burner tube 1 mounted above the conveyor 65 in FIG. 3a in more detail. In other words, in the arrangement of FIG. 3a, the slots 3 of each burner tube 1 are inclined to face towards the conveyor 65. Mounting the burner tubes 1 in this way has been found to provide further improvements in the efficiency of the burner tubes 1. It is thought this additional improvement in efficiency may be due to additional radiant heat being directly supplied to the product 68 by the visible flames and incandescing meshes 4 of the burner tubes 1.

Experiments have shown that the burner tubes 1 when mounted in the conventional manner (i.e. horizontally fired, with θ=0° show a 23% improvement in efficiency compared with conventional burner tubes. When the burner tubes 1 are mounted as shown in FIG. 3a i.e. inclined towards the conveyor 65 with θ=38°, the improvement in efficiency increases to 27%.

FIG. 4 shows a variety of configurations for the burner tube 1 which may be used to correct the “edge heating problem” (discussed above). These configurations all work by enabling the burner tube 1 in use to supply more heat at its ends than in the centre. Only a single end of the burner tube 1 is shown in the drawings. However, the arrangements are preferably duplicated at both ends of the burner tube 1.

In the arrangement shown in FIG. 4a, the width of a slot 3 widens towards the end of the slot 3 to make a flared end 31. In use, when combustible gas is fed through the burner tube 1, the flow rate of gas through the mesh 4 towards the end of the slot is increased. Therefore, in use, the burner tube 1 will supply more heat at the flared end of the slot 3 relative to the centre of the slot 3.

In the arrangement shown in FIG. 4b, the width of the mesh 4 widens towards the end of a slot 3 to make a flared end 41. The mesh 4 is attached such that the flow area of the mesh 4 (i.e. the area through which combustible gas is able to flow in use) is wider at the flared end 41. Therefore, the area of the visible flame and the incandescing mesh 4 is increased at the flared end 41 of the mesh 4. Therefore, more radiant heat is produced at the flared end 41 of the mesh relative to the radiant heat produced at the centre of the mesh 4.

FIG. 4c shows a combination of the arrangements shown in FIGS. 4a and 4b.

In the arrangement shown in FIG. 4d, the burner tube 1 includes a transverse slot 32 at an end of a slot 3. In use, the transverse slots 32 increases the flow rate of gas through the mesh 4 towards the end of the slot 3, thus increasing the heat supplied at the end of the slot 3.

In the arrangement shown in FIG. 4e, three holes 33 replace each of the transverse slots of FIG. 4d.

FIG. 4f shows the arrangement shown in FIG. 4d wherein the mesh 4 has a flared end 41 as shown in FIG. 4b.

FIG. 4g shows the arrangement shown in FIG. 4e wherein the mesh 4 has a flared end 41 as shown in FIG. 4b.

FIG. 4h shows an arrangement in which there are six additional holes 34 at the end of the burner tube 1. The holes 34 are positioned along side a slot 3.

FIG. 4i shows the arrangement shown in FIG. 4h wherein the mesh 4 has a flared end 41 as shown in FIG. 4b.

FIG. 4j shows the arrangement shown in FIG. 4h where a portion 42 of the mesh 4 covering the additional holes 34 is wider than the rest of the mesh 4. In this arrangement, the widening of the mesh is a stepped increase, rather than the width increasing gradually.

In the arrangement shown in FIG. 4k, there are three additional holes 35 at each end of the burner tube 1 and the portion 43 of the mesh 4 covering the additional holes 35 is wider than the rest of the mesh. In this arrangement, the widening of the mesh is a stepped increase, rather than the width increasing gradually.

In the arrangement shown in FIG. 4l, in addition to a slot 3, there is a flared slot 36 which is spaced from a slot 3 by a bridge 10. The mesh 4 covers both slots. The bridge 10 improves the structural integrity of the tubular body 2.

FIG. 5 shows another embodiment of the burner tube 1. This embodiment is configured as a “multizone” burner tube, in this case a “trizone” (three zone) burner tube. The “trizone” burner tube is designed to correct the “edge heating problem”.

In FIG. 5, the tubular body 2 is provided with internal distribution tubes 71a, 71b, 71c which are connected to a distributor 70 which is connected to a gas supply (not shown). The distributor 70 allows the flow of combustible gas through the distribution tubes 71a, 71b, 71c to be controlled independently.

Each distribution tube 71a, 71b, 71c has its outlet 72a, 72b, 72c at a different distance along the length of the tubular body 2. In this embodiment, the outlet 72a, 72b, 72c of each distribution tube 71a, 71b, 71c is a plurality of holes. Internal baffles (not shown) are used to divide the inside of tubular body 2 along its length into three zones, with each zone having one of the distribution tube outlets 72a, 72b, 72c therein.

By controlling the flow of gas through each of the distribution tubes 71a, 71b, 71c, the flow of gas through the slots 3 at different lengths along the slots 3 can be controlled. Therefore, by increasing the flow of gas through the tubes 71a, 71c which have their outlets 72a, 72c nearest the ends of the burner tube 1, the flow of gas through the slot is increased at the ends of the burner tube 1. Consequently, the heat output of the burner tube 1 is increased at the ends of the burner tube 1 in comparison with the centre of the burner tube 1.

FIG. 6 shows the tubular body 2 of the burner tube 1 in more detail. The tubular body 2 has been made by laser cutting a plurality of axially extending slots 3 which are linearly arranged to be end on end with narrow bridges 10 in the tubular body 2 therebetween. In this embodiment, the slots 3 are 150 mm in length with narrow bridges 10 of length 4 mm therebetween. The bridges 10 improve the structural integrity of the tubular body 2 and prevent deformation of the slots 3.

Although the tubular body 2 has been illustrated with a plurality of slots 3, the tubular body 2 can be made with only one slot instead.

One of ordinary skill after reading the foregoing description will be able to affect various changes, alterations, and subtractions of equivalents without departing from the broad concepts disclosed. It is therefore intended that the scope of the patent granted hereon be limited only by the appended claims, as interpreted with reference to the description and drawings, and not by limitation of the embodiments described herein.

1. A burner tube for use in an oven, the burner tube including:
a tubular body having an axially extending slot therein and an inlet for combustible gas; and
a metal mesh which covers the slot and is at the outermost surface of the burner tube;
in use, the burner tube defining a flow path for combustible gas so that combustible gas entering the burner tube at the inlet passes through the slot and exits the burner tube through a flow area of the metal mesh;
wherein, the flow area of the metal mesh is greater than the area of the slot at the outer surface of the tubular body and a visible flame is anchored to the flow area of the metal mesh when the burner tube is in use.

2. A burner tube according to claim 1 wherein the flow area of the metal mesh is at least 1.5 times, 2 times, 3 times or 4 times greater than the area of the slot at the outer surface of the tubular body.

3. A burner tube according to claim 1 wherein the metal mesh is a knitted metal fibre.

4. A burner tube according to claim 1 wherein the metal mesh is of a material which incandesces at temperatures in the range 600° C. to 1200° C.

5. A burner tube according to claim 1 wherein the metal mesh is of an Fe—Cr—Al steel.

6. A burner tube according to claim 1 wherein the metal mesh is attached directly to the outer surface of the tube.

7. (canceled)

8. A burner tube according to claim 1 wherein the metal mesh is mounted on a porous layer positioned between the slot and the metal mesh.

9. A burner tube according to claim 8 wherein the porous layer is rigid.

10. A burner tube according to claim 9 wherein the porous layer is a perforated metal plate.

11. A burner tube according to claim 1 wherein the flow area of the metal mesh is arranged to incandesce when the burner tube is in use.

12.-13. (canceled)

14. A burner tube according to claim 1 having only one mesh structure which covers the slot.

15. A burner tube according to claim 1 having a plurality of axially extending slots which are covered by the metal mesh.

16. A burner tube according to claim 1 having an outer diameter of less than 100 mm.

17. A burner tube according to claim 1 wherein the axially extending slot widens towards an end of the slot.

18. A burner tube according to claim 1 wherein the tube includes one or more additional openings located at an end of the slot, the additional openings being covered by the metal mesh.

19. A burner tube according to claim 1 wherein the flow area of the metal mesh widens towards an end of the slot.

20. A burner tube according to claim 1 wherein the tubular body has a plurality of axially extending slots therein, with the slots being linearly arranged end on end with bridges in the tubular body therebetween.

21. A burner tube according to claim 1 additionally including a distributor having at least two distribution pipes for supplying different flow rates of combustible gas to at least two zones which are axially distributed within the tubular body.

22. An oven including one or more burner tubes, each of the one or more burner tubes including:
a tubular body having an axially extending slot therein and an inlet for combustible gas; and
a metal mesh which covers the slot and is at the outermost surface of the burner tube;
in use, each burner tube defining a flow path for combustible gas so that combustible gas entering the burner tube at the inlet passes through the slot and exits the burner tube through a flow area of the metal mesh;
wherein the metal mesh of each burner tube is spaced apart from the area of the slot at the outer surface of the tubular body so that there is a space located between the mesh and the slot;
wherein, the flow area of the metal mesh of each burner tube is greater than the area of the slot at the outer surface of the tubular body and a visible flame is anchored to the flow area of the metal mesh when the burner tube is in use; and
wherein the metal mesh of each burner tube is a knitted metal fibre;
wherein the over further includes:
a tunnel; and
a conveyor having a surface for transporting a product through the tunnel thereon;
wherein each of the burner tubes is mounted with its axis transverse to the direction of motion of the conveyor surface;
wherein each of the burner tubes is mounted with its axis substantially perpendicular to the direction of motion of the conveyor;
wherein a line is defined which extends perpendicularly from the axis of the tubular body and passes through the centre of the slot is inclined towards the conveyor surface; and
wherein said line also passes through the conveyor surface.

23.-28. (canceled)

29. A method of producing a burner tube according to claim 1 including:
forming an axially extending slot in a tubular body by laser cutting.

30. (canceled)
